(19) United States
(12) Patent Application Publication
(10) Pub. No.: US 2009/0265131 A1
(43) Pub. Date: Oct. 22, 2009

(54) MEASUREMENT OF THE TEMPERATURE OF A MOLTEN GLASS BATH

(75) Inventors: Patrice Brun, Saint Michel D'Euzet (FR); Jacques Lacombe, Pujaut (FR); Yann Papin, Laudun (FR)

Correspondence Address: Nixon Peabody LLP, 200 Page Mill Road, Palo Alto, CA, 94306, US

(73) Assignee: AREVA NC, Paris (FR)

(21) Appl. No.: 12/278,135

(22) PCT Filed: Feb. 1, 2007
(86) PCT No.: PCT/EP2007/050963

§ 371 Date: Dec. 10, 2008

(30) Foreign Application Priority Data
Feb. 3, 2006 (FR) 06 50385

(51) Int. Cl. G01K 13/02; G06F 15/00

(52) U.S. Cl. 702/130; 374/141; 374/E13.006

(57) ABSTRACT

One proceeds with indirect measurement of the temperature of a molten bath (1) of a viscous material such as glass by measuring a parameter such as the motor torque of a rotating mechanical stirrer (3) or the heating power extracted from its coolant water. One thereby dispenses with direct measurement of the temperature by a rod provided with a thermocouple and subject to difficult operating conditions.

### CROSS REFERENCE TO RELATED APPLICATIONS OR PRIORITY CLAIM

This application is a national phase of International Application No. PCT/EP2007/050963, entitled “MEASURING THE TEMPERATURE OF A MOLTEN GLASS BATH”, which was filed on Feb. 1, 2007, and which claims priority of French Patent Application No. 06 50385, filed Feb. 3, 2006.

The subject of this invention is the measurement of the temperature of a bath of molten glass or of a very viscous material maintained at high temperature.

The measurement of such a temperature is required for monitoring vitrification processes, but it is difficult since the temperatures attained by the molten glass are very high. Most of the usual materials for building sensors melt or at least lose their strength. Another technique consists of measuring a lower temperature than the temperature actually attained by the glass by placing a temperature sensor in a rod cooled by a water flow. A gangue of solidified glass is formed around the rod and protects it from excessive heating and from corrosion. With correlation functions, the temperature of the molten glass bath may be inferred from the actually measured temperature. This measurement technique by a cooled rod is proven but inaccurate since it relates to a single location of the glass bath, the temperature of which may be heterogeneous, and it is very sensitive to the physical condition of the bath and notably to the natural or forced convection movements to which it is subject as well as to the thickness of solidified glass, which may also vary, which covers it.

These insufficiencies have led to the development, according to the present invention, of a measuring method where the direct measurement of the actual temperature or of a reduced temperature is replaced with the measurement of another parameter with which the temperature may be correlated by means of a function in order to accomplish an indirect measurement of the latter temperature. A common property to the contemplated parameters here, is that they are not associated with the molten bath and therefore do not require the placing of a sensor in the crucible containing the molten bath, but outside it, where it operates in a cooler medium under better conditions.

The invention is based on a particular use of a mechanical stirrer of the molten glass bath. Known stirrers are of various shapes and generally comprise a rotating body provided with blades or similar means for displacing the glass around them and producing a mixing. The stirrer is maintained at a moderate temperature by a circuit of coolant water which flows through it, in concentric conduits or otherwise.

The useful parameters for the measurement and which are correlated with the temperature of the melting baths are drawn from operating this stirrer. It should be noted that the cooling further generates a set solidified glass gangue around the stirrer, but this circumstance which was unfavorable in the case of a rod for measuring the temperature, is no longer so here, by the stirring which stabilizes the thickness of the fixed glass around the blades and the central shaft of the stirrer, and which regulates the condition of the bath around the blades; as the stirrer further is in direct contact with the largest portion of the molten bath, it receives heating which much better expresses the global temperature or the average temperature of the melting bath.

In a particular embodiment of the method of the invention, the measured parameter which expresses the temperature of the molten bath is the heating power extracted from the coolant fluid flowing through the stirrer. In another particular embodiment, the measured quantity is the motor torque of the stirrer, at a stable velocity.

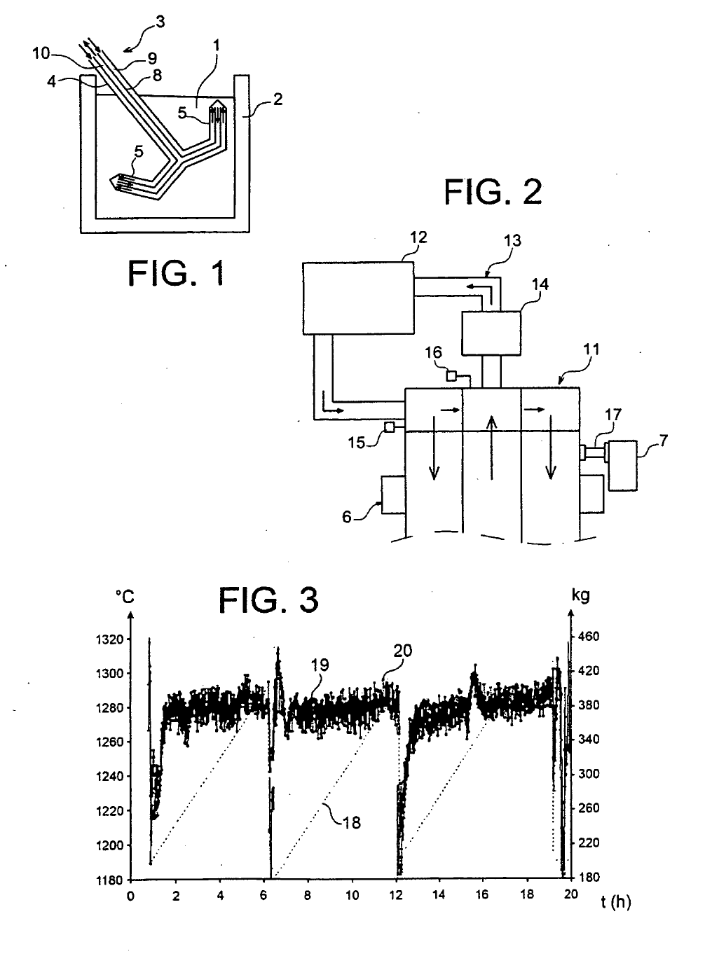

The invention will now be described with the help of FIG. 1, which illustrates a molten bath provided with a stirrer, FIG. 2 which illustrates the cooling circuit and FIG. 3 which illustrates an example. The bath bears the reference 1 and is found in a crucible 2 to which is added a heating means not shown and which may as this is frequently the case, consist in a single inducting coil positioned around the crucible 2. Neither the usual power supply means of the crucible nor the lower casting valve, well known in the prior art and foreign to the invention, are illustrated. The crucible 2 however contains a stirrer 3, here in the form of an anchor and comprising a plunger shaft 4 and a pair of opposite blades 5. The shaft 4 is supported by bearings 6 and driven into rotation by a motor 7 provided with a reducer and a torque variator. The stirrer 3 is hollow and comprises a central tube 8 dividing the interior between a peripheral channel 9 for injecting a water coolant and a central channel 10, concentrically with the former, where the injected water is picked up again. The tube 8 branches off into each of the blades and is open at its ends in order to allow the water to pass from the peripheral channel 9 to the central channel 10. The circuit further comprises a water box 11 placed at the top of the shaft 4, a pump 12, tubing 13 connecting the pump 12 to the water box 11 and comprising a suction conduit, a discharge conduit, and a cooling installation 14 on the tubing 13.

The invention would be operative with other stirrers, notably helical or coil-shaped stirrers. It is however appropriate that the cooling be regular and sufficient over the whole surface of the stirrer. Further, the blades 5 have sufficient extension so as to achieve global mixing of the molten bath. It should however be noted that the invention operates properly if it is applied on a small size stirrer of a molten bath provided with other stirrers on which no measurement is undertaken but which share the mixing function with the former.

In a particular embodiment of the invention, the heating power extracted by the stirrer 3 is measured, which may be inferred from the flow rate of the pump and from water coolant temperature measurements conducted by sensors 15 and 16 at the inlet of the peripheral channel 9 and at the outlet of the central channel 10. The applied formula for measuring the temperature is:

$${T}_{1} = {C}_{1} ln ( \frac{{C}_{2}}{P} ) ,$$

wherein T₁ is the sought temperature, C₁ and C₂ are constants empirically obtained by previous tests and P is the heating power. The constants only depend in practice on the rotational velocity of the stirrer and on the volume of the molten bath for a determined installation and composition of the molten bath.

In another embodiment of the invention, it is the motor torque of the stirrer, which is measured for accomplishing the indirect measurement of the temperature of the molten bath. The measurement is even easier and may be carried out by a torque-meter 17 placed on the transmission against the motor 7 and the shaft 3. The correlation formula is then of the

$${T}_{2} = {C}_{3} ln ( \frac{{C}_{4}}{C} )$$

type, wherein T₂ is the temperature of the molten bath (which should be the same as T₁), C₃ and C₄ are other constants determined by previous tests and C is the measured torque. Here again the constants C₃ and C₄ are invariable for the determined installation, and only depend on the rotational velocity and on the volume of molten material.

Both of these measuring methods may be used separately or together.

An example is given in FIG. 3, by applying the first formula, where the coefficients were C₁=−108.7 and C₂=0.0091 for the power P of the stirrer expressed in Watts and the temperature T₁, is expressed in degrees Celsius. The process comprised a series of cycles where the glass of constant composition was gradually poured into the crucible, and then rapidly removed after melting, according to the indication of the curve 18 which gives the glass weight in the crucible (in kilograms on the right ordinate scale) versus time (in hours on the abscissa scale). The parameters C₁ and C₂ were estimated in a previous cycle.

The actual temperature curves 19, measured by a thermocouple, of the melting bath, and those of the temperature 20 estimated according to the invention (on the left ordinate scale) are provided. These curves coincide perfectly, the curve 20 only having oscillations which assume the aspect of an envelope with a width of about 20° C. for the quasi-stable states of the cycles, which contains curve 19.

1. A method for measuring the temperature of a molten glass bath (1), by correlating a quantity measured at said temperature with a function established beforehand, characterized in that the measured quantity is drawn from a mobile mechanical stirrer (3) in the molten bath for mixing it.

2. The temperature measurement method according to claim 1, characterized in that the measured quantity is the heating power extracted from a coolant fluid flowing through the stirrer and calculated from the flow rate of the fluid and from the heating-up of the fluid from the inlet to the outlet of the stirrer.

3. The temperature measurement method according to claim 2, characterized in that the function is
$${T}_{1} = {C}_{1} ln ( \frac{{C}_{2}}{P} ) ,$$
wherein T₁, is the temperature, C₁ and C₂ are constants and P is the heating power.

4. The temperature measurement method according to claim 1, the stirrer being a rotating stirrer, characterized in that the measured quantity is the motor torque of the stirrer at a stable velocity.

5. The temperature measurement method according to claim 4, characterized in that the function is
$${T}_{2} = {C}_{3} ln ( \frac{{C}_{4}}{C} ) ,$$
wherein T₂ is the temperature, C₁ and C₂ are constants and C is the torque.
